(19) United States
(12) Patent Application Publication
(10) Pub. No.: US 2026/0138486 A1
(43) Pub. Date: May 21, 2026

(54) DISPLAY APPARATUS

(71) Applicant: SUBARU CORPORATION, Tokyo (JP)

(72) Inventors: Tsukasa MIKUNI, Tokyo (JP); Junichi MOTOYAMA, Tokyo (JP); Ryota NAKAMURA, Tokyo (JP); Takeshi SAITO, Tokyo (JP); Yuto AOKI, Tokyo (JP)

(21) Appl. No.: 19/448,470

(22) Filed: Jan. 14, 2026

Related U.S. Application Data
(63) Continuation of application No. PCT/JP2023/030317, filed on Aug. 23, 2023.

(51) Int. Cl. B60L 53/62; G06F 3/147; H02J 7/80

(52) U.S. Cl. CPC B60L 53/62; G06F 3/147; H02J 7/80

(57) ABSTRACT

A display apparatus is configured to be applied to a vehicle and includes a data acquirer, a display information generator, and a display. The data acquirer is configured to acquire data on a source of electric power supplied to charge a storage battery of the vehicle. The data on the source is source data, and includes a rate of generated electric power that is based on renewable energy of electric power to be supplied to each region and a rate of generated electric power that is based on electric power other than the renewable energy. The display information generator is configured to generate, based on the source data, display information on the rate, for each source, of the electric power stored in the storage battery. The display is configured to display the display information.

### CROSS-REFERENCE TO RELATED APPLICATIONS

This application is continuation of International Application No. PCT/JP2023/030317, filed on Aug. 23, 2023, the entire contents of which are hereby incorporated by reference.

### BACKGROUND

The disclosure relates to a display apparatus.

In recent years, a vehicle such as an electric vehicle having a storage battery chargeable by an external power source has become widespread from a viewpoint of environmental protection.

In general, an electric vehicle includes a display apparatus that displays information such as a remaining charge amount of a storage battery or a cruising distance and prompts a driver who drives the vehicle to pay attention so that the storage battery is not completely discharged during traveling.

For example, Japanese Unexamined Patent Application Publication (JP-A) No. 2010-149553 discloses a technique that displays the remaining charge amount of the storage battery on a meter assembly designed to display a speed of a vehicle.

### SUMMARY

An aspect of the disclosure provides a display apparatus configured to be applied to a vehicle. The display apparatus includes a data acquirer, a display information generator, and a display. The data acquirer is configured to acquire data on a source of electric power supplied to charge a storage battery of the vehicle. The data on the source is source data, and includes a rate of generated electric power that is based on renewable energy of electric power to be supplied to each region and a rate of generated electric power that is based on electric power other than the renewable energy. The display information generator is configured to generate, based on the source data, display information on the rate, for each source, of the electric power stored in the storage battery. The display is configured to display the display information.

An aspect of the disclosure provides a display apparatus to be applied to a vehicle. The display apparatus includes one or more processors, one or more memories communicably coupled to the one or more processors, and a display. The one or more processors are configured to: acquire data on a source of electric power supplied to charge a storage battery of the vehicle, in which the data on the source is source data, and includes a rate of generated electric power that is based on renewable energy of electric power to be supplied to each region and a rate of generated electric power that is based on electric power other than the renewable energy; generate, based on the source data, display information on the rate, for each source, of the electric power stored in the storage battery; and cause the display to display the display information.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of a display apparatus according to one example embodiment of the disclosure.

FIG. 2 is a diagram illustrating a configuration of a processor of the display apparatus illustrated in FIG. 1.

FIG. 3 is a diagram exemplifying source data of electric power acquired by the display apparatus illustrated in FIG. 1.

FIG. 4 is a diagram illustrating a display example of the display apparatus illustrated in FIG. 1.

FIG. 5 is a diagram illustrating a display example of the display apparatus illustrated in FIG. 1.

FIG. 6 is a diagram illustrating a flow of processes to be performed by the display apparatus illustrated in FIG. 1.

FIG. 7 is a diagram illustrating a configuration of a display apparatus according to one example embodiment of the disclosure.

FIG. 8 is a diagram illustrating a configuration of a processor of the display apparatus illustrated in FIG. 7.

FIG. 9 is a diagram illustrating a flow of processes to be performed by the display apparatus illustrated in FIG. 7.

### DETAILED DESCRIPTION

From a viewpoint of environmental protection, it is ideal that electric power to be used to charge a storage battery of a vehicle such as an electric vehicle be all supplied from generated electric power that is based on renewable energy, including electric power generated based on renewable energy such as solar light. In actuality, however, the electric power to be used to charge the storage battery is generally supplied by both generated electric power that is based on non-renewable energy such as fossil fuel and generated electric power that is based on renewable energy.

A technique including JP-A No. 2010-149553, however, lacks a functionality that displays source information on a source of the electric power stored in the storage battery of the vehicle. Accordingly, it is difficult for a driver who drives the vehicle to recognize a degree of contribution to environmental protection.

It is desirable to provide a display apparatus that makes it possible for a driver who drives a vehicle to recognize a degree of contribution to environmental protection by displaying source information on a source of electric power stored in a storage battery of the vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

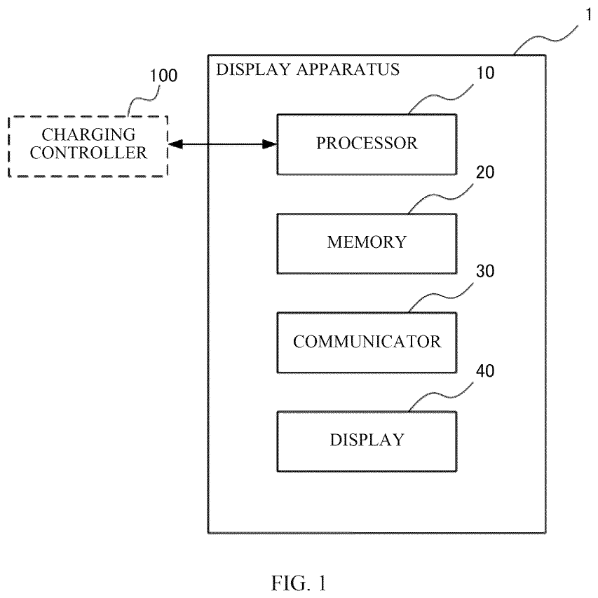

A display apparatus according to some example embodiments of the disclosure will be described with reference to FIGS. 1 to 9.

### First Example Embodiment

A display apparatus 1 according to an example embodiment will be described with reference to FIGS. 1 to 5.

### <Configuration of Display Apparatus 1>

Referring to FIG. 1, the display apparatus 1 according to the example embodiment may include a processor 10, a memory 20, a communicator 30, and a display 40.

The processor 10 may acquire, from a charging controller 100, data such as data on the start or the end of charging and data on a remaining charge amount of a storage battery. The charging controller 100 may control the charging of the storage battery of a vehicle.
The processor 10 causes the display 40 to display information on a rate, for each source, of electric power stored in the storage battery of the vehicle.
A configuration of the processor 10 will be described later.

The memory 20 may include a read-only memory (ROM) and a random-access memory (RAM) which are unillustrated.
The memory 20 may store, for example, a control program and various pieces of data received from the processor 10.

The communicator 30 may be a wireless communication module connectable to a network.
For example, the communicator 30 may communicate with, via an Internet network, a server in which source data on a source of the electric power is stored.

The display 40 may be any display panel such as a liquid crystal display. The display 40 displays display information received from the processor 10.
For example, the display 40 may be a meter panel included in the vehicle.

### <Configuration of Processor 10>

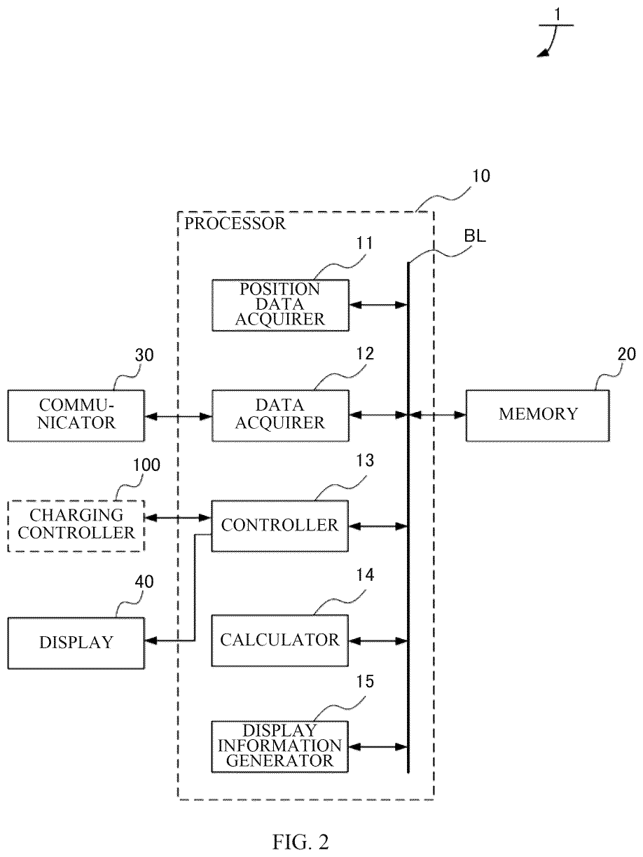

Referring to FIG. 2, the processor 10 includes a data acquirer 12 and a display information generator 15. The processor 10 may include a position data acquirer 11, a controller 13, and a calculator 14.
Each part of the processor 10 and the memory 20 may transmit and receive various types of data via a bus line BL.

The position data acquirer 11 may acquire position data on a position at which the storage battery of the vehicle is charged.
The position data acquirer 11 may acquire position data, based on radio waves received from a global positioning system (GPS).
The position data acquirer 11 may acquire the position data, when data indicating that the charging of the storage battery is to be started is received from the later-described controller 13.
The position data acquirer 11 may transmit the acquired position data to the later-described controller 13 via the bus line BL.

The data acquirer 12 acquires the source data on electric power that is supplied to charge the storage battery of the vehicle.
The data acquirer 12 may acquire data on a rate of generated electric power that is based on renewable energy and a rate of generated electric power that is based on electric power other than the renewable energy, out of the electric power supplied to charge the storage battery.
Hereinafter, the generated electric power based on the renewable energy is referred to as “renewable energy power”, and the generated electric power based on the electric power other than the renewable energy is referred to as “general electric power”.
The renewable energy power may be any electric power generated by solar light, wind power, hydroelectric power, geothermal heat, solar heat, biomass, or any other means by which the renewable energy power is generatable.
The general electric power may be any electric power generated by a fossil fuel such as petroleum, coal, or natural gas, reserved resources such as uranium, or any other material by which general electric power is generatable.

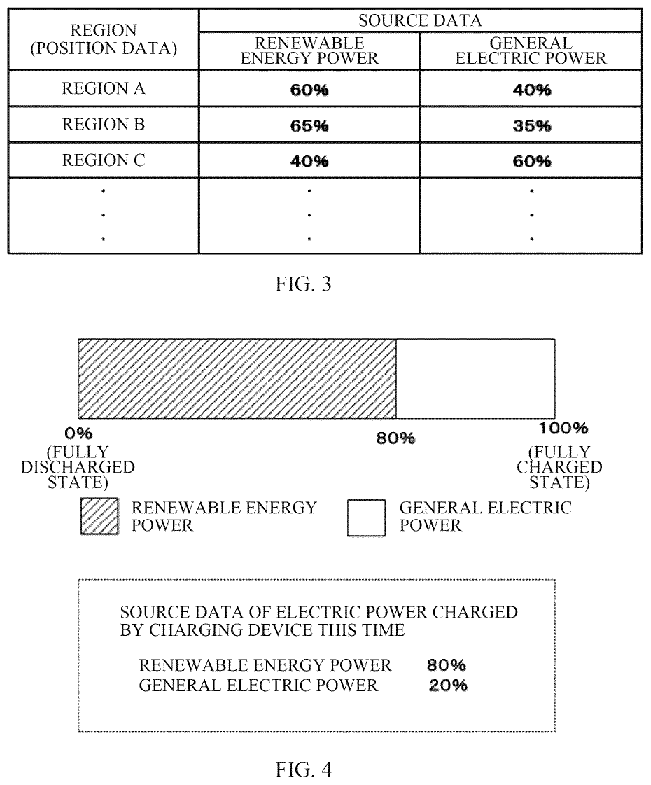

The data acquirer 12 may acquire the source data associated with the position data.
The data acquirer 12 may acquire the source data on the electric power to be supplied to a region that includes the position data received from the position data acquirer 11.
For example, the data acquirer 12 may be coupled, via the communicator 30, to a server in which the source data, for each region, on the electric power is stored as illustrated in FIG. 3, and acquire the data on the rate of the renewable energy power and the rate of the general electric power.
The data acquirer 12 may acquire the source data on the electric power of the region that includes the position data received from the later-described controller 13.
The data acquirer 12 may transmit the acquired source data on the electric power to the later-described controller 13 via the bus line BL.

The controller 13 may control the display apparatus 1 as a whole, based on a control program stored in the memory 20.
For example, in the example embodiment, the controller 13 may acquire, from the charging controller 100, the data on the start or the end of the charging and the data on the remaining charge amount of the storage battery.
In the example embodiment, the controller 13 may determine whether the charging of the storage battery is started, based on the data acquired from the charging controller 100, for example.
When the controller 13 determines that the charging of the storage battery is started, the controller 13 may transmit, to the position data acquirer 11 and the data acquirer 12 via the bus line BL, an instruction to start the charging.
In the example embodiment, the controller 13 may calculate an amount of electric power charged in the storage battery, based on the remaining charge amount at the start of the charging and the remaining charge amount at the end of the charging.
For example, the controller 13 may transmit, to the later-described calculator 14 via the bus line BL, the amount of electric power charged in the storage battery, the remaining charge amount of the storage battery, and the source data on the electric power.
The controller 13 may control the display 40 and cause the display 40 to display information on the rate, for each source, of the electric power stored in the storage battery.
The controller 13 may transmit, to the display 40, the display information received from the later-described display information generator 15.

The calculator 14 may calculate the rate, for each source, of the electric power stored in the storage battery, based on the source data of the electric power.
For example, the calculator 14 may calculate the rate of the renewable energy power of the electric power stored in the storage battery and the rate of the general electric power stored in the storage battery, based on the amount of electric power charged in the storage battery, the remaining charge amount of the storage battery, and the source data of the electric power that are received from the controller 13.
The calculator 14 may transmit a result of the calculation to the controller 13 via the bus line BL.

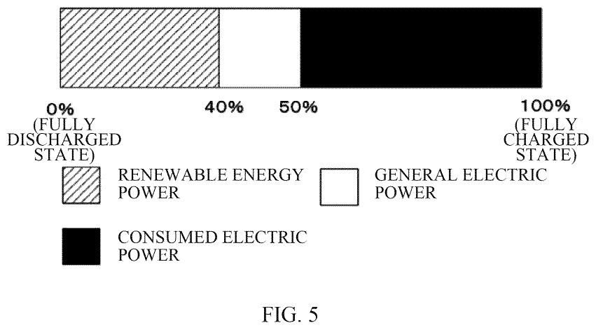

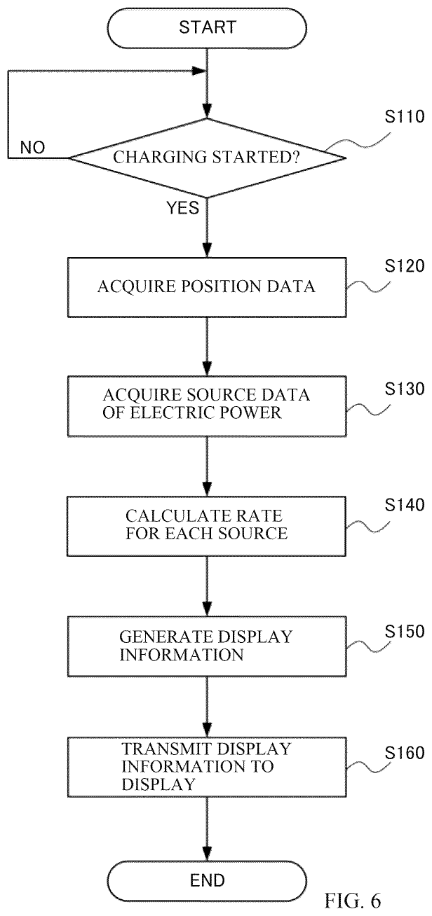

The display information generator 15 generates the display information on the rate, for each source, of the electric power stored in the storage battery.
The display information generator 15 may generate the display information on the rate, for each source, of the electric power stored in the storage battery, based on the amount of electric power charged in the storage battery, the remaining charge amount of the storage battery of the vehicle, and the result of the calculation of the calculator 14 that are received from the controller 13.
Referring to FIG. 4, the display information generator 15 may generate, for example, a graph in which the amount of electric power in a fully discharged state of the storage battery is 0% and the amount of electric power in a fully charged state is 100%.
For example, the display information generator 15 may generate a graph indicating the rate of the renewable energy power and the rate of the general electric power out of the amount of electric power currently stored in the storage battery, based on the remaining charge amount received from the controller 13 and the result of the calculation of the calculator 14.
For example, the display information generator 15 may generate the display information indicating a numerical value of the source data of the electric power charged from a charging device, based on the source data on the electric power received from the data acquirer 12.
Referring to FIG. 5, the display information generator 15 may update the display information, when the electric power of the storage battery is consumed due to a factor such as the traveling of the vehicle.
The display information generator 15 may transmit the generated display information to the controller 13 via the bus line BL.
The display information generator 15 may display, on the display 40, the rate of the renewable energy power and the rate of the general electric power of the electric power stored in the storage battery. Accordingly, a display mode of the display information to be displayed on the display 40 is not limited to any of the display mode described above.

### <Processes of Display Apparatus 1>

A flow of processes to be performed by the display apparatus 1 will be described with reference to FIG. 6.

Referring to FIG. 6, the controller 13 may determine whether the charging of the storage battery is started (step S110).
If the controller 13 determines that the charging of the storage battery is not started (“NO” in step S110), the controller 13 may return the process and shift to a standby state.
If the controller 13 determines that charging of the storage battery is started (“YES” in step S110), the controller 13 may cause the process to proceed to step S120.

The controller 13 may transmit, to the position data acquirer 11, data indicating that the charging of the storage battery is to be started, and cause the position data acquirer 11 to acquire the position data of the vehicle (step S120).

The controller 13 may transmit, to the data acquirer 12, the data indicating that the charging of the storage battery is to be started, and cause the data acquirer 12 to acquire the source data on the electric power associated with the position data acquired in step S120 (step S130).

The controller 13 may transmit, to the calculator 14, the amount of electric power charged in the storage battery, the remaining charge amount in the storage battery, and the source data of the electric power, and cause the calculator 14 to calculate the rate, for each source, of the electric power stored in the storage battery (step S140).

The controller 13 may transmit, to the display information generator 15, the amount of electric power charged in the storage battery, the remaining charge amount in the storage battery of the vehicle, and the result of the calculation obtained in step S140, and cause the display information generator 15 to generate the display information on the rate, for each source, of the electric power stored in the storage battery (step S150).

The controller 13 may transmit the display information generated in step S150 to the display 40 (step S160), and end the process.

### <Working and Example Effects>

The display apparatus 1 according to the example embodiment includes the data acquirer 12, the calculator 14, the display information generator 15, and the display 40. The data acquirer 12 is configured to acquire the source data of the electric power supplied to charge the storage battery of the vehicle. The calculator 14 is configured to calculate the rate, for each source, of the electric power stored in the storage battery, based on the source data of the electric power. The display information generator 15 is configured to generate the display information on the rate, for each source, of the electric power stored in the storage battery, based on the result of the calculation performed by the calculator 14. The display 40 is configured to display the display information.
Thus, the display apparatus 1 visualizes and displays the rate, for each source, of the electric power stored in the storage battery of the vehicle.
Accordingly, the display apparatus 1 helps to allow the driver to recognize a degree of contribution to environmental protection.

In some embodiments, the data acquirer 12 of the display apparatus 1 may acquire the rate of the generated electric power that is based on the renewable energy and the generated electric power that is based on the electric power other than the renewable energy.
Thus, the display apparatus 1 may visualize that the electric power stored in the storage battery of the vehicle includes the renewable energy power.
Accordingly, the display apparatus 1 helps to allow the driver to recognize that he or she contributes to the environmental protection.

In some embodiments, the display apparatus 1 may include the position data acquirer 11 configured to acquire the position data on the position at which the charging of the storage battery of the vehicle is performed, and the data acquirer 12 may acquire the source data associated with the position data.
Thus, the data acquirer 12 may acquire the source data on the electric power supplied to the region where the charging device by which the vehicle has actually performed the charging is disposed.
Accordingly, the display apparatus 1 helps to accurately display the rate, for each source, of the electric power stored in the storage battery.

### Second Embodiment

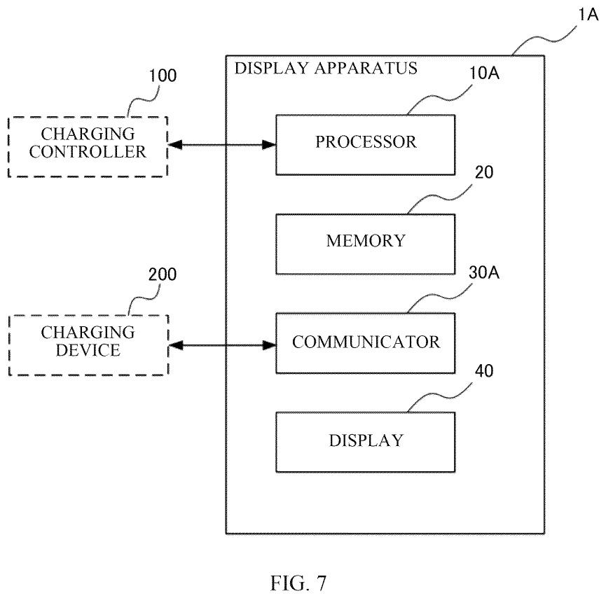

A display apparatus 1A according to a second example embodiment will be described with reference to FIGS. 7 to 9.
Components denoted by the same reference numerals as those in the first embodiment may have similar functions thereto; thus they will not be detailed in detail.

### <Configuration of Display Apparatus 1A>

Referring to FIG. 7, the display apparatus 1A according to the example embodiment may include a processor 10A, the memory 20, a communicator 30A, and the display 40.

For example, the processor 10A may acquire, from the charging controller 100, the data such as data on the start or the end of the charging and the data on the remaining charge amount of the storage battery. The charging controller 100 may control the charging of the storage battery of the vehicle.
A configuration of the processor 10A will be described later.

The communicator 30A may be a communication device that communicates with a charging device 200.
The communicator 30A may communicate with the charging device 200 via a charging cable of the charging device 200 using any communication method such as a controller area network (CAN) or a power line communication (PLC).

The charging device 200 may charge the storage battery of the vehicle.
For example, the charging device 200 may acquire in advance, from a server in which the source data of the electric power is stored, the source data on the electric power supplied to the region where the charging device 200 is disposed.
The charging device 200 may store the acquired source data on the electric power in a memory provided in the charging device 200.
For example, the charging device 200 to which an electric power generating device such as a solar panel is coupled may calculate the rate of the renewable energy power and the rate of the general electric power, based on an amount of electric power generated by the device such as the solar panel and the source data on the electric power acquired from the server.

### <Configuration of Processor 10A>

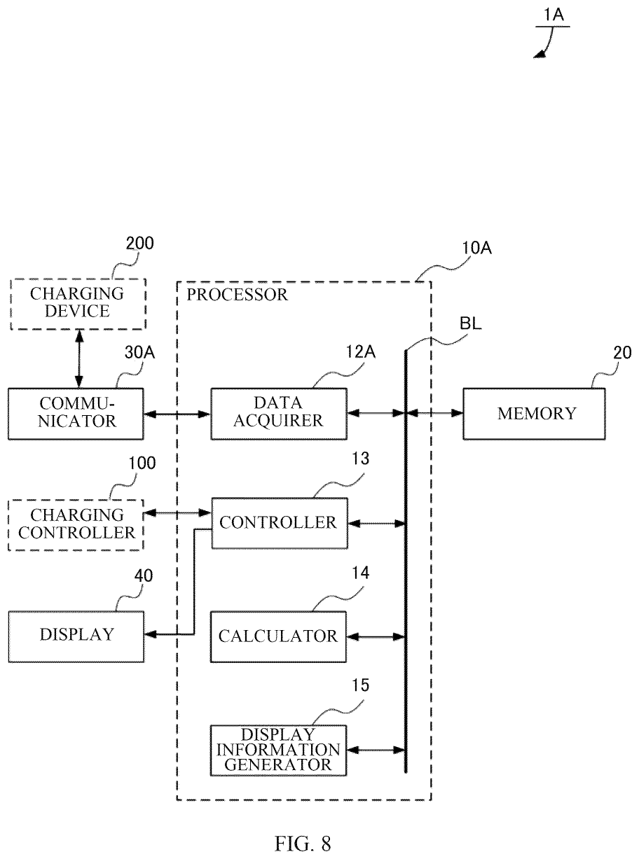

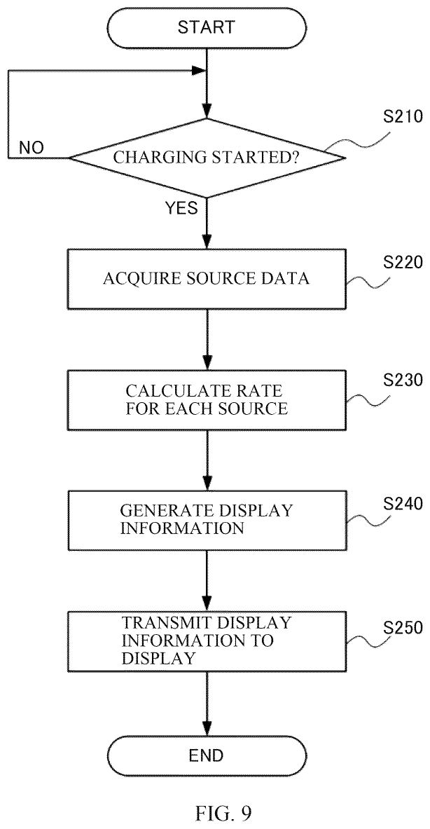

Referring to FIG. 8, the processor 10A may include a data acquirer 12A, the controller 13, the calculator 14, and the display information generator 15.
Each part of the processor 10A and the memory 20 may transmit and receive various types of data via the bus line BL.

The data acquirer 12A may acquire the source data of the electric power that is supplied to charge the storage battery of the vehicle.
The data acquirer 12A may acquire data on the rate of the renewable electric power and the rate of the general electric power, out of the electric power supplied to charge the storage battery.
The data acquirer 12A may acquire the source data from the charging device 200 that has charged the storage battery.
For example, the data acquirer 12A may acquire, via the communicator 30A, the data on the rate of the renewable energy power and the rate of the general electric power out of the electric power supplied from the charging device 200, when the data acquirer 12A has received from the controller 13 the data indicating that the charging of the storage battery is to be started.
The data acquirer 12A may transmit the acquired source data on the electric power to the controller 13 via the bus line BL.

### <Processes of Display Apparatus 1A>

A flow of processes to be performed by the display apparatus 1A will be described with reference to FIG. 9.

Referring to FIG. 9, the controller 13 may determine whether the charging of the storage battery is started (step S210).
If the controller 13 determines that the charging of the storage battery is not started (“NO” in step S210), the controller 13 may return the process and shift to a standby state.
If the controller 13 determines that the charging of the storage battery is started (“YES” in step S210), the controller 13 may cause the process to proceed to step S220.

The controller 13 may transmit, to the position data acquirer 12A, the data indicating that the charging of the storage battery is to be started, and cause the position data acquirer 12A to acquire the source data on the electric power from the charging device 200 (step S220).

The controller 13 may transmit, to the calculator 14, the amount of electric power charged in the storage battery, the remaining charge amount in the storage battery, and the source data on the electric power, and cause the calculator 14 to calculate the rate, for each source, of the electric power stored in the storage battery (step S230).

The controller 13 may transmit, to the display information generator 15, the amount of electric power charged in the storage battery, the remaining charge amount in the storage battery of the vehicle, and the result of the calculation obtained in step S230, and cause the display information generator 15 to generate the display information on the rate, for each source, of the electric power stored in the storage battery (step S240).

The controller 13 may transmit the display information generated in step S240 to the display 40 (step S250), and end the process.

### <Working and Example Effects>

The display apparatus 1A according to the example embodiment includes the data acquirer 12A, the calculator 14, the display information generator 15, and the display 40. The data acquirer 12A is configured to acquire the source data on the electric power supplied to charge the storage battery of the vehicle. The calculator 14 is configured to calculate the rate, for each source, of the electric power stored in the storage battery, based on the source data of the electric power. The display information generator 15 is configured to generate the display information on the rate, for each source, of the electric power stored in the storage battery, based on the result of the calculation performed by the calculator 14. The display 40 is configured to display the display information.

The data acquirer 12A may acquire the source data on the electric power from the charging device 200 that has actually charged the vehicle.
Thus, the display apparatus 1 visualizes and displays the rate, for each source, of the electric power stored in the storage battery of the vehicle, based on the source data of the electric power obtained from the charging device 200 that has actually performed the charging of the vehicle.
Accordingly, the display apparatus 1A helps to allow the driver to recognize that the vehicle is traveling with the renewable electric power, which in turn allow the driver to recognize that he or she contributes to the environmental protection.

### Modification Example 1

In some embodiments, the display apparatus 1 or the display apparatus 1A according to the example embodiment may display the rate, for each source, of the electric power stored in the storage battery, based on the source data on the electric power stored in advance in the memory 20, when the source data of the electric power is not acquired for some reason.
For example, the display apparatus 1 or the display apparatus 1A may display the rate, for each source, of the electric power stored in the storage battery, based on data on a rate of the renewable electric power and a rate of the electric power in the whole country.
Accordingly, the display apparatus 1 or the display apparatus 1A helps to display the rate, for each source, of the electric power stored in the storage battery even when the source data is not acquired, which in turn allow the driver to recognize that he or she contributes to the environmental protection.

### Modification Example 2

In some embodiments, the display apparatus 1 or the display apparatus 1A according to the example embodiment may add an amount of electric power charged in the storage battery by the regenerative braking to the renewable energy power, and display the rate, for each source, of the electric power stored in the storage battery.
Accordingly, the display apparatus 1 or the display apparatus 1A helps to allow the driver to recognize that he or she contributes to the environmental protection.

### Modification Example 3

In some embodiments, the display apparatus 1 according to the example embodiment may superimpose, based on the source data on the electric power acquired from the server, the source data on the electric power for each region on map data and display the superimposed map information.
For example, the display apparatus 1 may display a recommended charging region where the rate of renewable energy power is high on a map, and recommend the driver to perform the charging in the recommended charging region.
Accordingly, the display apparatus 1 helps to allow the driver to recognize that he or she further contributes to the environmental protection, when the vehicle is charged in the recommended charging region.

In some embodiments, a program that causes the process to be performed by one or more of the controller 13, the calculator 14, and the display information generator 15 to be recorded on a non-transitory recording medium readable by a computer system. The display apparatus 1 or the display apparatus 1A according to the example embodiment of the disclosure may be implemented by causing a memory of the computer system to load the program recorded in the non-transitory recording medium and causing the computer system to execute the program.
The computer system as used herein may encompass an operating system (OS) and a hardware such as a peripheral device.

The “computer system” may encompass a website providing environment or a website displaying environment, when the computer system utilizes a World Wide Web (WWW) system.
The program may be transmitted from the computer system that contains the program in a device such as a storage device to another computer system via a transmission medium or by a carrier wave in a transmission medium.
The “transmission medium” designed to transmit the program may refer to a medium having a capability to transmit data, including: a network or a communication network such as the Internet; and a communication link or a communication line such as a telephone line.

The program may be directed to implement a part of the operation described above. The program may be a so-called differential file or differential program designed to implement the operation by a combination of the program already recorded on the computer system.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.
The limitations in the claims are to be interpreted broadly based on the language employed in the claims and not limited to examples described in this specification or during the prosecution of the application, and the examples are to be construed as non-exclusive.
As used in this specification and the appended claims, the singular forms “a,” “an,” and “the” include, especially in the context of the claims, are to be construed to cover both the singular and the plural, unless otherwise indicated herein or clearly contradicted by context.
Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.
The use of the terms first, second, etc. do not denote any order or importance, but rather the terms first, second, etc. are used to distinguish one element from another.
The term “substantially”, “approximately”, “about”, and its variants having the similar meaning thereto are defined as being largely but not necessarily wholly what is specified as understood by one of ordinary skill in the art.
The term “disposed on/provided on/formed on” and its variants having the similar meaning thereto as used herein refer to elements disposed directly in contact with each other or indirectly by having intervening structures therebetween.

The controller 13, the calculator 14, and the display information generator 15 illustrated in FIGS. 2 and 8 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the controller 13, the calculator 14, and the display information generator 15. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the controller 13, the calculator 14, and the display information generator 15 illustrated in FIGS. 1 and 8.

1. A display apparatus configured to be applied to a vehicle, the display apparatus comprising:
a data acquirer configured to acquire data on a source of electric power supplied to charge a storage battery of the vehicle, the data on the source being source data, and comprising a rate of generated electric power that is based on renewable energy of electric power to be supplied to each region and a rate of generated electric power that is based on electric power other than the renewable energy;
a display information generator configured to generate, based on the source data, display information on the rate, for each source, of the electric power stored in the storage battery; and
a display configured to display the display information.

2. The display apparatus according to claim 1, further comprising a position data acquirer configured to acquire position data on a position at which charging of the storage battery of the vehicle is performed, wherein
the data acquirer is configured to acquire the source data associated with the position data.

3. The display apparatus according to claim 1, wherein the data acquirer is configured to acquire the source data from a charging device by which charging of the storage battery is performed.

4. A display apparatus to be applied to a vehicle, the display apparatus comprising:
one or more processors;
one or more memories communicably coupled to the one or more processors; and
a display, wherein
the one or more processors are configured to
acquire data on a source of electric power supplied to charge a storage battery of the vehicle, the data on the source being source data, and comprising a rate of generated electric power that is based on renewable energy of electric power to be supplied to each region and a rate of generated electric power that is based on electric power other than the renewable energy,
generate, based on the source data, display information on the rate, for each source, of the electric power stored in the storage battery, and
cause the display to display the display information.
